(19) United States
(12) Patent Application Publication
(10) Pub. No.: US 2022/0335447 A1
(43) Pub. Date: Oct. 20, 2022

(54) SYSTEMS AND METHODS FOR OBJECT PREFERENCE PREDICTION

(71) Applicant: Capital One Services, LLC, McLean, VA (US)

(72) Inventors: Tyler Maiman, Melville, NY (US); Abdelkader M'Hamed Benkreira, Brooklyn, NY (US); Brendan Way, Brooklyn, NY (US)

(73) Assignee: Capital One Services, LLC, McLean, VA (US)

(21) Appl. No.: 17/230,378

(22) Filed: Apr. 14, 2021

(51) Int. Cl. G06Q 30/02; G06N 20/00; G06N 5/04; G06Q 30/06

(52) U.S. Cl. CPC G06Q 30/0201; G06N 20/00; G06N 5/04; G06Q 30/0631

(57) ABSTRACT

A system can include a machine learning model trained to develop preference profiles based on historical user interaction data and instructions that, when executed by the one or more processors, cause the computing system to perform operations. The operations can include receiving, from one or more third party networks, historical user interaction data associated with a first user; processing the historical user interaction data with the machine learning model to generate the preference profile of the first user; receiving, from a user device associated with a second user, an identifier associated with the first user; detecting an object displayed on the user device; generating, via the machine learning model, a compatibility score based on comparing the detected object to the preference profile of the first user; and causing the compatibility score to be displayed on the user device.

### TECHNICAL FIELD

Embodiments of the present disclosure relate to object preference prediction using machine learning and interaction data.

### BACKGROUND OF THE DISCLOSURE

Purchasing items for others, whether as a gift or out of necessity, can be a frustrating and stressful task and people often will have to rely on their own guesswork. It can be difficult to know what other people's preferences are in terms of brands, categories, product types, colors, particular items, etc. It can be even more difficult to estimate a person's clothing size. As a result of these difficulties, it is not uncommon for a purchaser to give a gift to a recipient that the recipient does not like, does not need, and/or cannot wear because of an incorrect size. Occasionally, purchasers may opt to utilize gift cards or money as an alternative.

Such uncertainty in item and gift purchasing can have negative impacts on more than just the purchaser: the recipient of the gifts can often be unsatisfied with gifts they don't like or items that don't fit. In addition, receiving a gift card or cash as a gift can also lead to dissatisfaction. On top of that, high frequencies of returns and/or exchanges can create burdensome costs for online retailers and merchants.

### SUMMARY OF THE DISCLOSURE

According to one aspect of the present disclosure, a computing system can include one or more processors and a non-transitory computer-readable medium. The medium can include a machine learning model trained to develop preference profiles based on historical user interaction data; and instructions that, when executed by the one or more processors, cause the computing system to perform operations. The operations can include receiving, from one or more third party networks, historical user interaction data associated with a first user; processing the historical user interaction data with the machine learning model to generate a preference profile of the first user; receiving, from a user device associated with a second user, an identifier associated with the first user; detecting an object displayed on the user device; generating, via the machine learning model, a compatibility score based on comparing the object to the preference profile of the first user; and causing the compatibility score to be displayed on the user device.

In some embodiments, receiving historical user interaction data associated with the first user can include at least one of: receiving financial transaction data from one or more financial services networks, the financial transaction data comprising stock-keeping unit (SKU) level data; receiving transaction data from one or more merchant networks; or receiving at least one of receipt or order information from an email account associated with the first user. In some embodiments, detecting the object displayed on the user device can include at least one of receiving uniform resource locator (URL) information from the user device; receiving image data for the object from the user device; or receiving text data from a webpage associated with the object from the user device.

In some embodiments, the image data was obtained via a browser extension on the user device. In some embodiments, processing the historical user interaction data with the machine learning model to develop the preference profile of the first user can include generating at least one preference, wherein generating the at least one preference can include determining that a purchase frequency associated with the at least one preference exceeds a pre-defined threshold. In some embodiments, processing the historical user interaction data with the machine learning model to develop the preference profile of the first user comprises utilizing a clustering algorithm to create a plurality of product category clusters.

In some embodiments, processing the historical user interaction data with the machine learning model to develop the preference profile of the first user can include analyzing spending levels by a plurality of other users on at least one category; and cleaning the historical user interaction data based on the spending levels. In some embodiments, the operations can further include receiving an indication from the second user that the object was purchased; receiving feedback from the second user on the object; and updating the preference profile for the first user based on the indication and the feedback.

According to another aspect of the present disclosure, a computer-implemented method performed by a server can include receiving, from one or more third party networks, historical user interaction data associated with a first user; processing the historical user interaction data with a machine learning model to generate a preference profile of the first user, wherein the machine learning model is trained to develop preference profiles based on historical user interaction data; receiving, from a user device associated with a second user, an identifier associated with the first user; detecting an object displayed on the user device; generating, via the machine learning model, a compatibility score based on comparing the object to the preference profile of the first user; and causing the compatibility score to be displayed on the user device.

In some embodiments, receiving historical user interaction data associated with the first user can include at least one of receiving financial transaction data from one or more financial services networks, the financial transaction data comprising stock-keeping unit (SKU) level data; receiving transaction data from one or more merchant networks; or receiving at least one of receipt or order information from an email account associated with the first user. In some embodiments, detecting the object displayed on the user device can include at least one of: receiving uniform resource locator (URL) information from the user device; receiving image data for the object from the user device; or receiving text data from a webpage associated with the object from the user device.

In some embodiments, the image data was obtained via a browser extension on the user device. In some embodiments, processing the historical user interaction data with the machine learning model to develop the preference profile of the first user can include generating at least one preference, wherein generating the at least one preference can include determining that a purchase frequency associated with the at least one preference exceeds a pre-defined threshold.

In some embodiments, processing the historical user interaction data with the machine learning model to develop the preference profile of the first user can include utilizing a clustering algorithm to create a plurality of product category clusters. In some embodiments, processing the historical user interaction data with the machine learning model to develop the preference profile of the first user can include: analyzing spending levels by a plurality of other users on at least one category; and cleaning the historical user interaction data based on the spending levels. In some embodiments, the method can further include receiving an indication from the second user that the object was purchased; receiving feedback from the second user on the object; and updating the preference profile for the first user based on the indication and the feedback.

According to another aspect of the present disclosure, a method can include activating a browser extension enabling a first user to select an object displayed within a web browser installed on a user device; transmitting an identifier associated with a second user to a server; in response to the first user selecting the object, obtaining information associated with the object; transmitting the information associated with the object to the server; receiving, from the server, a compatibility score associated with the object, the compatibility score reflecting a likelihood that the second user will like the object; and displaying the compatibility score on the user device.

In some embodiments, the method can further include receiving an indication that the object was purchased; receiving, from the first user or the second user, feedback on the object; and transmitting the indication and the feedback to the server. In some embodiments, the information associated with the object can include at least one of: uniform resource locator (URL) information from the user device; image data for the object from the user device; or text data from a webpage associated with the object from the user device. In some embodiments, the compatibility score is generated by comparing, via a machine learning model, the information associated with the object to a preference profile associated with the second user.

### BRIEF DESCRIPTION OF THE FIGURES

FIG. 1 is a block diagram of an example system for improving transaction categorization using natural language processing according to some embodiments of the present disclosure.

FIGS. 2A and 2B are flow diagrams showing example processing that can occur within the system of FIG. 1, according to some embodiments of the present disclosure.

FIG. 3 is another flow diagram showing example processing that can occur within the system of FIG. 1, according to some embodiments of the present disclosure.

FIG. 4 is an example server device that can be used within the system of FIG. 1 according to an embodiment of the present disclosure.

FIG. 5 is an example computing device that can be used within the system of FIG. 1 according to an embodiment of the present disclosure.

### DETAILED DESCRIPTION

Embodiments of the present disclosure relate to an intelligent gifting tool. In particular, the disclosed systems and methods can leverage artificial intelligence and machine learning techniques to process and analyze aggregated merchant and transaction data and provide insights to online shoppers on behalf of gift recipients. The intelligent gifting tool can access historical interaction and transaction data for a user and develop, via machine learning techniques, a preference profile for the user based on their historical transactions and purchases. The preference profile can include various pieces of information such as preferred brands, colors, types of products, etc. and more “necessary” preferences such as clothing and/or shoe sizes. The system can be configured to develop preference profiles for its userbase. Once the preference profiles have been generated, they can be utilized to assist other users in making transactions. For example, a user purchasing a gift can activate the intelligent gifting tool as an extension in a web browser while shopping. Once an item is on the page (e.g., a product webpage at Macy's, such as a coffee maker or item of clothing), the user can input an identifier of the intended gift recipient into the browser extension. The tool can detect the item, predict, using the machine learning techniques, whether the item is compatible with the recipient's preference profile, generate a compatibility score, and display the score on the purchaser's web browser. In other words, the intelligent gifting tool can predict, based off a user's transaction history, whether the user will be satisfied with an item or product. The purchaser can then make their buying decisions based on these predictions.

Such a tool can provide various benefits, such as increased buyer confidence when purchasing gifts online, increased satisfaction of gift recipients, and both significant computational and monetary savings on the merchant end. As discussed earlier, frequent returns and exchanges can incur significant burdens for online retailers, as they must process the initial transaction, reverse the transaction, and cover the costs associated with the shipping back and forth and associated computation. In addition, it can be difficult to accurately track the stock of items that experience frequent returns and exchanges, especially when shipping is involved in each step of the process. Countless man- and computer-hours can be spent trying to manage and ensure inventory counts are up to date. Finally, other systems that attempt to track user's item preferences typically involve users having to manually input what their preferences are; this can be both tedious and inaccurate. It is not uncommon for perceived self-preferences to be inaccurate. And while these types of systems may be used to make item recommendations to the associated user, there can be privacy issues involved in being too thorough in evaluating user preferences and publishing them to other people. The systems and methods of the present disclosure can overcome these issues.

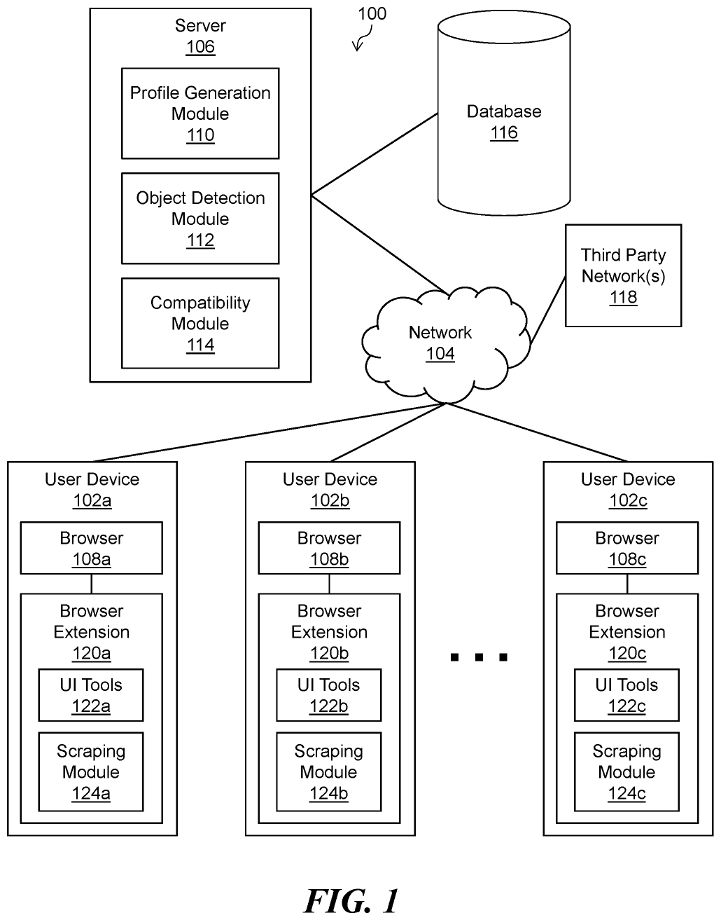

FIG. 1 is a block diagram of an example intelligent gifting system 100 (e.g., a computing system), according to some embodiments of the present disclosure. The system 100 can include a plurality of user devices 102a-c (generally referred to herein as a “user device 102” or collectively referred to herein as “user devices 102”) and a server 106, which are communicably coupled via a network 104. Components of the system 100 can also communicate with one or more third party networks 118 (e.g., financial services networks, merchant networks, etc.) via the network 104. In some embodiments, the server 106 is configured to receive historical transactions from the one or more third party networks 118. For example, in response to a user (e.g., of a payment instrument or of a purchasing account at a merchant website) authorizing a purchase transaction of a good or service, the one or more third party networks 118 can send the transaction and associated transaction information to the server 106. In some embodiments, this may occur in real-time. The server 106 can store the received transactions and associated information in the database 116.

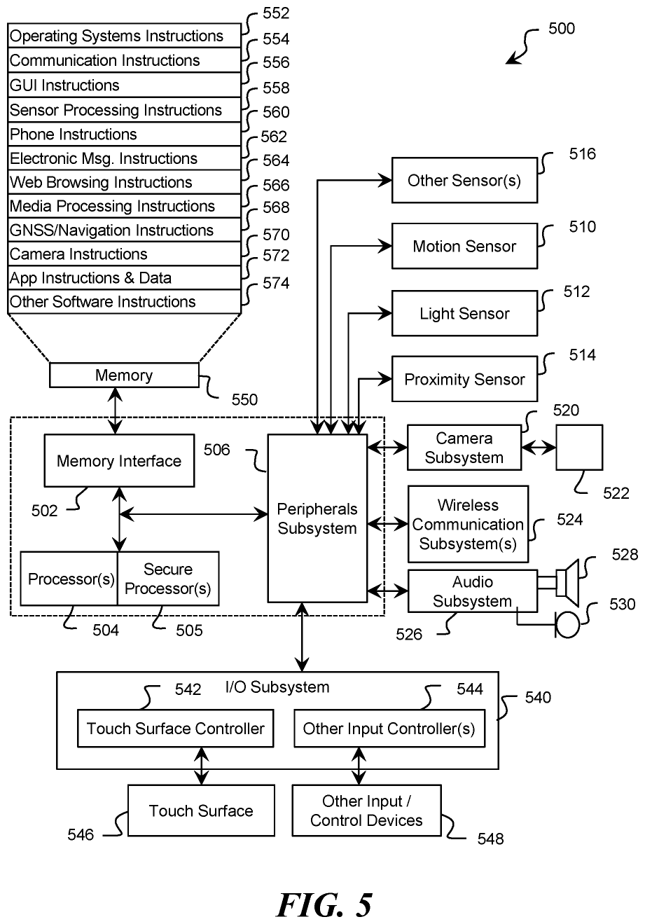

A user device 102 can include one or more computing devices capable of receiving user input, transmitting and/or receiving data via the network 104, and or communicating with the server 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, or other suitable device. In some embodiments, a user device 102 can be the same as or similar to the user device 500 described below with respect to FIG. 5. In some embodiments, the system 100 can include any number of user devices 102.

As shown in FIG. 1, a user device can include an installed web browser (or “browser”) 108 (e.g., browsers 108a-c) that may display web pages, and a corresponding browser extension 120 (e.g., browsers 120a-c). Browser 108 may be any of a variety of conventional web browsers, including, but not limited to, Google Chrome™, Firefox™, Internet Explorer®, Microsoft Edge®, or Safari®. Browser 108 may also be a customer browser developed by, for example, a financial institution (e.g., Capital One) and provided to customers of the financial institution. In addition to the features and extensions described herein, browser 108 can include other features such as a café browsing module that protects the users' personal information.

Browser extension 120 may be a software component configured to add features to and enhance the functionality of the corresponding browser 108. In Google Chrome™ browser extension 120 would be referred to as an “extension”. In Firefox, browser extension 120 would be referred to as an “add-on”. In Internet Explorer, browser extension 120 may be referred to as an “add-on”, an “extension”, or a “toolbar”. In Microsoft Edge or Safari®, browser extension 120 may be referred to as an “extension”. Browser extension 120 can include UI tools 122 (e.g., UI tools 122a-c) and a scraping module 124 (e.g., scraping modules 124a-c). Browser extension 120 may be downloaded from server 106 to user device 102 and may be used to run an intelligent gifting tool within browser 108.

Browser extension 120 may be configured to allow users to input recipient information and perform a screen grab or selection of a product or item. For example, after navigating to a product webpage (e.g., a grill product page at Target) via browser 108, a user can activate the browser extension 120 via a browser button. After the browser extension 120 becomes activated, the user can input information identifying a recipient (e.g., name, email, username, etc.). In addition, the user can utilize UI tools 122 to select a product or item within the browser 108. For example, the UI tools 122 can provide a click and drag tool to the user to select a hypertext markup language (HTML) element (div/frame) that corresponds to the product. The selection can also capture image data, a referrer uniform resource locator (URL), a forwarding URL, or other metadata of the product webpage. In some embodiments, UI tools 122 can also prompt the user to input other information identifying the item or product. After selection, the captured data is sent to server 106 via network 104 for processing. In some embodiments, the browser extension 120 can also scrape data and/or images from the webpage via scraping module 124. Additionally, after access is provided by a user, the scraping module 124 can be configured to scrape an electronic mail account to obtain email receipts and/or confirmation emails from orders to obtain transaction information or order information.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

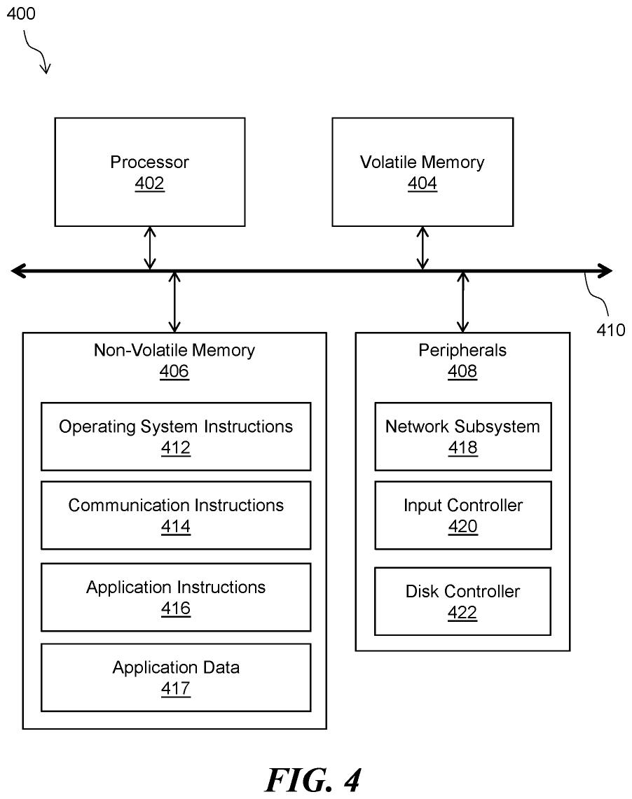

Server 106 may include any combination of one or more of web servers, mainframe computers, general-purpose computers, personal computers, or other types of computing devices. Server 106 may represent distributed servers that are remotely located and communicate over a communications network, or over a dedicated network such as a local area network (LAN). Server 106 may also include one or more back-end servers for carrying out one or more aspects of the present disclosure. In some embodiments, server 106 may be the same as or similar to server device 400 described below in the context of FIG. 4.

As shown in FIG. 1, the server 106 includes a profile generation module 110, an object detection module 112, and a compatibility module 114. The server is communicably coupled to the database 116. The server 106, as described above, is configured to receive transactions from one or more third party networks 118. In some embodiments, receiving a transaction can include receiving various associated information such as, but not limited to, an amount, payment method, date, time, and description. Profile generation module 110 can be configured to generate a preference profile for a user based on the transaction data stored in database 116 (discussed in more detail below) via machine learning techniques. For example, the profile generation module 110 can maintain a machine learning module that is trained to develop and/or maintain preference profiles for its userbase. In addition, object detection module 112 can be configured to analyze an image received from a user device 102 (e.g., captured or selected with UI tools 122) and determine an object within an image. The object detection module 112 can also be configured to extract details and/or text data from the image and/or determine the type of product and various other information about the object. In some embodiments, compatibility module 114 can be configured to receive data describing a product or item (e.g., one detected via object detection module 112) and information identifying a recipient and determine a compatibility score for the product based on the recipient's preference profile. Server 106 can be configured to cause a determined compatibility score to be displayed on a browser 108 of a user device 102 while a user is shopping.

The server 106 can maintain a dataset of historical transactions from a userbase (e.g., the users associated with the user devices 102) within the database 116. In some embodiments, database 116 can store email transaction information, such as email headers, from addresses, subject lines, as well as item level data and confirmations. Database 116 can also store user-created survey and preference data. In some embodiments, database 116 can also store store-keeping unit level data from financial transactions (e.g., L3 data); this can include detailed purchase information such as the store, item or product number, color, size, variant/style information, etc. After profiles are created by the profile generation module 110, they can be stored in the database 116. In some embodiments, database 116 can store the profile as a preference schema, wherein the schema identifies stores, categories (e.g., outdoors), brands, subcategories (e.g., camping), variant/styles, sizes, item names, colors, etc. The data stored in database 116 can also be indexed by user or user identifier.

The various system components—such as modules 110-114 and 122-124—may be implemented using hardware and/or software configured to perform and execute the processes, steps, or other functionality described in conjunction therewith.

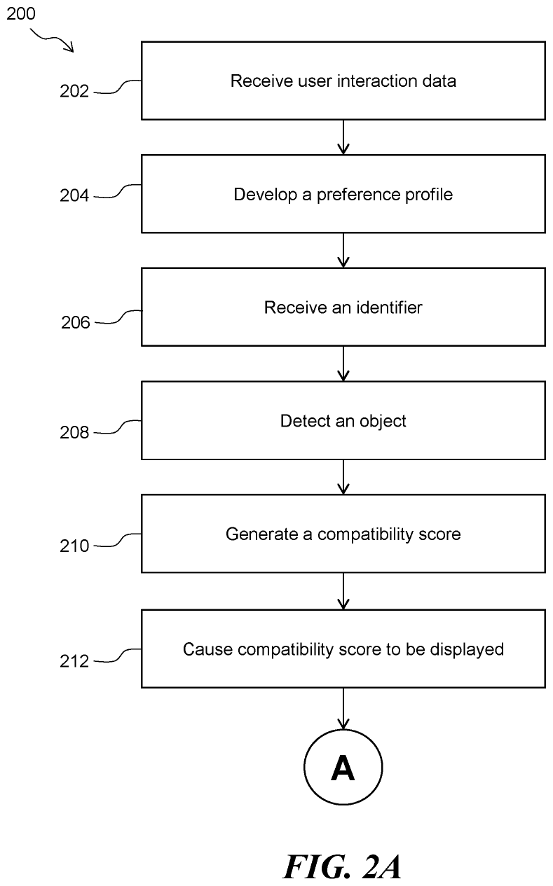

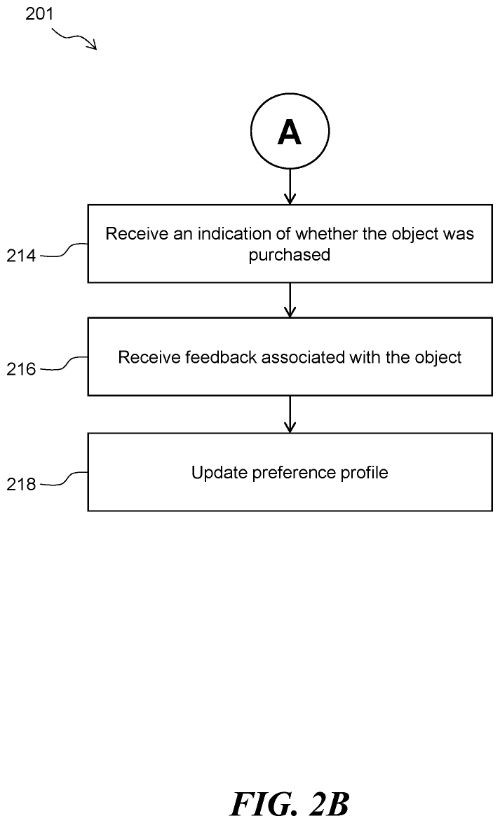

FIGS. 2A and 2B are flow diagrams showing example processing that can occur within the system of FIG. 1, according to some embodiments of the present disclosure. For example, FIG. 2A shows a process 200, which can be performed by server 106 and its various modules. In some embodiments, process 200 can be performed to assist a user in purchasing a gift or item for a recipient; in other words, the process 200 can provide an intelligent gifting tool, as described herein. In some embodiments, process 200 can be part of a software development kit (SDK) at a merchant website during checkout. At block 202, server 106 receives user interaction data associated with a recipient, such as from the one or more third party networks 118 in system 100. For example, server 106 can receive (sometimes in real-time) financial transaction data from a financial network, such as a credit card issuer, that manages a payment account for the recipient. In addition, server 106 can receive transaction data from a merchant network; for example, the recipient may have a Macy's merchandise account and the account's transaction history may be received by the server 106. In some embodiments, the received data can include store stock-keeping unit (SKU) level data from financial transactions (e.g., L3 data); this can include detailed purchase information such as the store, brand, item or product number, color, size, variant/style information, etc. In addition, server 106 can receive information from a tool (e.g., scraping module 124 or via server 106 itself) that scrapes data from an email account. The data can include email transaction information, such as email headers, from addresses, subject lines, as well as item level data and confirmations. In some embodiments, the interaction data can be received over a period of time.

At block 204, profile generation module 110 can develop a preference profile for the recipient based on the data received at block 202. In some embodiments, the profile generation module 110 can develop the preference profile for a user utilizing machine learning techniques. For example, a machine learning model can, based on the recipient's historical transactions (e.g., both purchases and returns), determine a user's preferences for various factors, such as desired clothing and shoe sizes, desired colors, desired categories, etc. For example, purchases of certain products may suggest that the recipient prefers a certain type of item, while a return may suggest otherwise. As described herein, this data can be referred to as historical user interaction data. In some embodiments, the machine learning model can analyze the frequencies of occurrence of the factors and use a plurality of thresholds to determine preferences. For example, if a determined frequency (e.g., a purchase frequency) exceeds a pre-defined threshold, the machine learning model may determine that the user “prefers” a category, item, or other factor associated with those purchases. In some embodiments, the machine learning model can utilize clustering algorithms (e.g., k-nearest neighbor (KNN) clustering) to create product category clusters, where the various category clusters can correspond to categories that the recipient likes and categories that the user does not like. In some embodiments, the preference profiles can be developed using ensemble learning, combining several types of models, such as clustering models for product categories and quantification and classification models for other factors, such as size and color.

In some embodiments, the profile generation module 110 can also be configured to, when developing a preference profile, utilize purchase and transaction data from other users that are part of the system. For example, the profile generation module 110 can help distinguish between relevant transactions and irrelevant transactions, and then develop the preference profile based only on the relevant transactions; this can be referred to as cleaning the historical transaction data of the userbase. Irrelevant transactions can include needs or “necessary” purchases, such as bathroom products, gas bills, and the like. In some embodiments, the profile generation module 110 can determine relative spending patterns across different users of the userbase and use the relative spending patterns or spending levels to determine if a category or product type is considered irrelevant or not. For example, a majority of the userbase may spend a similar percentage of money per month on bathroom products, therefore, these could be considered irrelevant products and excluded from the profile generation. However, if a particular user were to spend much more than that percentage in a month on bathroom products, this could indicate an anomaly and trigger the purchases to be considered during profile generation.

At block 206, compatibility module 114 can receive an identifier from the user device 102; for example, the identifier can be an email address, name, user ID, phone number, or any other identifying information that can be used to identify a recipient of the gift. The user, via user device 102, can enter the identifier into the web browser 108, such as at an input bubble in the browser extension 120. At block 208, object detection module 112 can detect an object on a webpage of the user device 102. In some embodiments, the detection can occur manually by the user entering in information related to the product. In other embodiments, the user can capture an image of the product using UI tools 122 and/or scraping module 124; the image would then be transmitted to the object detection module 112 for processing. In some embodiments, scraping module 124 can scrape various information from the webpage itself, such as text and product descriptions. At block 210, the compatibility module 114 can generate a compatibility score for the object detected at block 208. The compatibility score can be detected by comparing the detected object and associated information identifying the detected object with the preference profile associated with the identifier received at block 206. The compatibility score can be a prediction of whether the recipient will like the object or not. At block 212, the server 106 can cause the compatibility score to be displayed on the browser 108 of the user device 102.

FIG. 2B is a flow diagram showing example process 201 that can occur to categorize a transaction using natural language processing according to some embodiments of the present disclosure. In some embodiments, process 201 can be performed by server 106 after completion of process 200. At block 214, profile generation module 110 can receive an indication of whether the object (e.g., the object detected at block 208 and associated with the generated compatibility score) was purchased. At block 216, the profile generation module 110 can further receive feedback associated with the object, such as whether the gift recipient enjoyed the object. In some embodiments, the feedback can be text-based and free form, binary, or can be an input within a numerical range (e.g., how much did the recipient enjoy the gift on a scale of 1-10). The information received by profile generation module 110 at blocks 214 and 216 can be received from a user device 102 associated with the user purchasing the object, such as via the web browser extension 120. At block 218, the profile generation module 110 can update the preference profile for the gift recipient based on the feedback and indication received at blocks 214 and 216. For example, if the feedback included that the recipient returned the gift because it was too big, the profile generation module 110 can update the preference profile to reflect this.

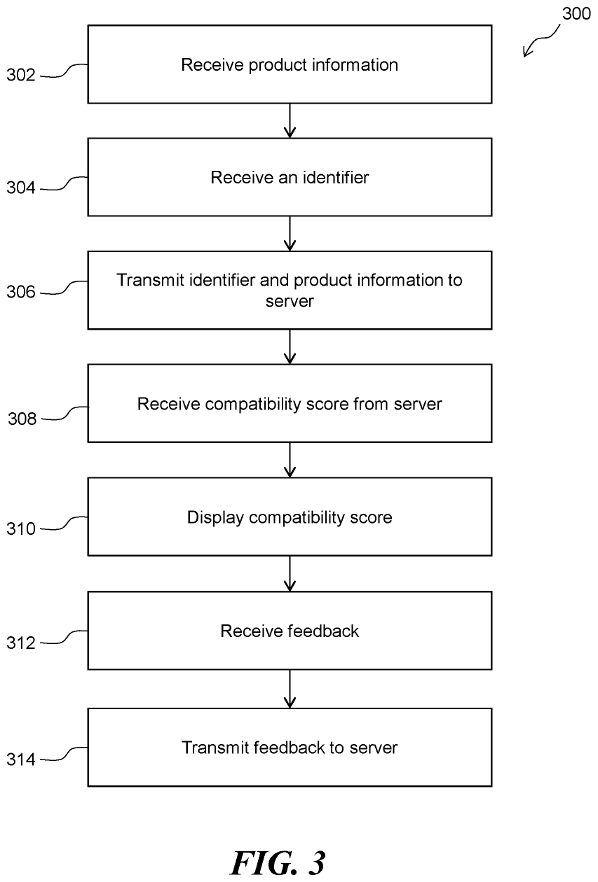

FIG. 3 is a flow diagram showing example process 300 that can occur to categorize a transaction using natural language processing according to some embodiments of the present disclosure. In some embodiments, process 300 can be performed by a user device, such as user device 102 of FIG. 1. At block 302, the user device 102 can receive product information, such as via scraping module 124 and/or UI tools 122. In some embodiments, the product information can include an image of a product or object. At block 304, user device 102 can receive an identifier, such as an email address, name, user ID, phone number, or any other identifying information that can be used to identify a recipient of a gift. In some embodiments, the identifier can be received via a web browser extension 120 on a web browser 108 of the user device 102. At block 306, the user device 102 can transmit the identifier and the product information to a server for processing, such as server 106.

At block 308, the user device 102 can receive a compatibility score from the server 106. The compatibility score can represent a prediction or likelihood that the gift recipient associated with the identifier transmitted at block 306 will like the gift. At block 310, the compatibility score can be displayed on the user device 102, such as in the web browser 108. In some embodiments, the score can range from zero to one. At block 312, user device 102 can receive feedback from the user. In some embodiments, the feedback associated with the object can indicate whether the gift recipient enjoyed the object. In some embodiments, the feedback can be text-based and free form, binary, and/or can be an input within a numerical range (e.g., how much did the recipient enjoy the gift on a scale of 1-10). The feedback can be received from a user via the browser extension 120. At block 314, the feedback can be transmitted from the user device 102 to server 106 for processing by the profile generation module 110 to update the gift recipient's preference profile.

FIG. 4 is a diagram of an example server device 400 that can be used within system 100 of FIG. 1. Server device 400 can implement various features and processes as described herein. Server device 400 can be implemented on any electronic device that runs software applications derived from complied instructions, including without limitation personal computers, servers, smart phones, media players, electronic tablets, game consoles, email devices, etc. In some implementations, server device 400 can include one or more processors 402, volatile memory 404, non-volatile memory 406, and one or more peripherals 408. These components can be interconnected by one or more computer buses 410.

Processor(s) 402 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 410 can be any known internal or external bus technology, including but not limited to ISA, EISA, PCI, PCI Express, USB, Serial ATA, or FireWire. Volatile memory 404 can include, for example, SDRAM. Processor 402 can receive instructions and data from a read-only memory or a random access memory or both. Essential elements of a computer can include a processor for executing instructions and one or more memories for storing instructions and data.

Non-volatile memory 406 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 406 can store various computer instructions including operating system instructions 412, communication instructions 414, application instructions 416, and application data 417. Operating system instructions 412 can include instructions for implementing an operating system (e.g., Mac OS®, Windows®, or Linux). The operating system can be multi-user, multiprocessing, multitasking, multithreading, real-time, and the like. Communication instructions 414 can include network communications instructions, for example, software for implementing communication protocols, such as TCP/IP, HTTP, Ethernet, telephony, etc. Application instructions 416 can include instructions for providing an intelligent gifting tool according to the systems and methods disclosed herein. For example, application instructions 416 can include instructions for components 110-114 described above in conjunction with FIG. 1. Application data 417 can include data corresponding to 110-114 described above in conjunction with FIG. 1. In some embodiments, the processes described herein (processes 200, 201, and 300) can be stored as instructions in a non-transitory computer-readable medium; in some embodiments, each of these processes can be a computer-implemented method.

Peripherals 408 can be included within server device 400 or operatively coupled to communicate with server device 400. Peripherals 408 can include, for example, network subsystem 418, input controller 420, and disk controller 422. Network subsystem 418 can include, for example, an Ethernet of WiFi adapter. Input controller 420 can be any known input device technology, including but not limited to a keyboard (including a virtual keyboard), mouse, track ball, and touch-sensitive pad or display. Disk controller 422 can include one or more mass storage devices for storing data files; such devices include magnetic disks, such as internal hard disks and removable disks; magneto-optical disks; and optical disks.

FIG. 5 is an example computing device that can be used within the system 100 of FIG. 1, according to an embodiment of the present disclosure. In some embodiments, device 500 can be any of user devices 102a-n. The illustrative user device 500 can include a memory interface 502, one or more data processors, image processors, central processing units 504, and/or secure processing units 505, and peripherals subsystem 506. Memory interface 502, one or more central processing units 504 and/or secure processing units 505, and/or peripherals subsystem 506 can be separate components or can be integrated in one or more integrated circuits. The various components in user device 500 can be coupled by one or more communication buses or signal lines.

Sensors, devices, and subsystems can be coupled to peripherals subsystem 506 to facilitate multiple functionalities. For example, motion sensor 510, light sensor 512, and proximity sensor 514 can be coupled to peripherals subsystem 506 to facilitate orientation, lighting, and proximity functions. Other sensors 516 can also be connected to peripherals subsystem 506, such as a global navigation satellite system (GNSS) (e.g., GPS receiver), a temperature sensor, a biometric sensor, magnetometer, or other sensing device, to facilitate related functionalities.

Camera subsystem 520 and optical sensor 522, e.g., a charged coupled device (CCD) or a complementary metal-oxide semiconductor (CMOS) optical sensor, can be utilized to facilitate camera functions, such as recording photographs and video clips. Camera subsystem 520 and optical sensor 522 can be used to collect images of a user to be used during authentication of a user, e.g., by performing facial recognition analysis.

Communication functions can be facilitated through one or more wired and/or wireless communication subsystems 524, which can include radio frequency receivers and transmitters and/or optical (e.g., infrared) receivers and transmitters. For example, the Bluetooth (e.g., Bluetooth low energy (BTLE)) and/or WiFi communications described herein can be handled by wireless communication subsystems 524. The specific design and implementation of communication subsystems 524 can depend on the communication network(s) over which the user device 500 is intended to operate. For example, user device 500 can include communication subsystems 524 designed to operate over a GSM network, a GPRS network, an EDGE network, a WiFi or WiMax network, and a Bluetooth™ network. For example, wireless communication subsystems 524 can include hosting protocols such that device 500 can be configured as a base station for other wireless devices and/or to provide a WiFi service.

Audio subsystem 526 can be coupled to speaker 528 and microphone 530 to facilitate voice-enabled functions, such as speaker recognition, voice replication, digital recording, and telephony functions. Audio subsystem 526 can be configured to facilitate processing voice commands, voice-printing, and voice authentication, for example.

I/O subsystem 540 can include a touch-surface controller 542 and/or other input controller(s) 544. Touch-surface controller 542 can be coupled to a touch-surface 546. Touch-surface 546 and touch-surface controller 542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 546.

The other input controller(s) 544 can be coupled to other input/control devices 548, such as one or more buttons, rocker switches, thumb-wheel, infrared port, USB port, and/or a pointer device such as a stylus. The one or more buttons (not shown) can include an up/down button for volume control of speaker 528 and/or microphone 530.

In some implementations, a pressing of the button for a first duration can disengage a lock of touch-surface 546; and a pressing of the button for a second duration that is longer than the first duration can turn power to user device 500 on or off. Pressing the button for a third duration can activate a voice control, or voice command, module that enables the user to speak commands into microphone 530 to cause the device to execute the spoken command. The user can customize a functionality of one or more of the buttons. Touch-surface 546 can, for example, also be used to implement virtual or soft buttons and/or a keyboard.

In some implementations, user device 500 can present recorded audio and/or video files, such as MP3, AAC, and MPEG files. In some implementations, user device 500 can include the functionality of an MP3 player, such as an iPod™. User device 500 can, therefore, include a 36-pin connector and/or 8-pin connector that is compatible with the iPod. Other input/output and control devices can also be used.

Memory interface 502 can be coupled to memory 550. Memory 550 can include high-speed random access memory and/or non-volatile memory, such as one or more magnetic disk storage devices, one or more optical storage devices, and/or flash memory (e.g., NAND, NOR). Memory 550 can store an operating system 552, such as Darwin, RTXC, LINUX, UNIX, OS X, Windows, or an embedded operating system such as VxWorks.

Operating system 552 can include instructions for handling basic system services and for performing hardware dependent tasks. In some implementations, operating system 552 can be a kernel (e.g., UNIX kernel). In some implementations, operating system 552 can include instructions for performing voice authentication.

Memory 550 can also store communication instructions 554 to facilitate communicating with one or more additional devices, one or more computers and/or one or more servers. Memory 550 can include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic messaging-related process and functions; web browsing instructions 564 to facilitate web browsing-related processes and functions; media processing instructions 566 to facilitate media processing-related functions and processes; GNSS/Navigation instructions 568 to facilitate GNSS and navigation-related processes and instructions; and/or camera instructions 570 to facilitate camera-related processes and functions.

Memory 550 can store application (or “app”) instructions and data 572, such as instructions for the apps described above in the context of FIGS. 1-3. Memory 550 can also store other software instructions 574 for various other software applications in place on device 500.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Other implementations are within the scope of the following claims. Accordingly, the scope of the invention should be determined not by the embodiments illustrated, but by the appended claims and their equivalents.

1. A computing system comprising one or more processors and a non-transitory computer-readable medium, the medium comprising:
a machine learning model trained to develop preference profiles based on historical user interaction data; and
instructions that, when executed by the one or more processors, cause the computing system to perform operations comprising:
receiving, from one or more third party networks, historical user interaction data associated with a first user;
processing the historical user interaction data with the machine learning model to generate a preference profile of the first user;
receiving, from a user device associated with a second user, an identifier associated with the first user;
detecting an object displayed on the user device;
generating, via the machine learning model, a compatibility score based on comparing the object to the preference profile of the first user; and
causing the compatibility score to be displayed on the user device.

2. The computing system of claim 1, wherein receiving historical user interaction data associated with the first user comprises at least one of:
receiving financial transaction data from one or more financial services networks, the financial transaction data comprising stock-keeping unit (SKU) level data;
receiving transaction data from one or more merchant networks; or
receiving at least one of receipt or order information from an email account associated with the first user.

3. The computing system of claim 1, wherein detecting the object displayed on the user device comprises at least one of:
receiving uniform resource locator (URL) information from the user device;
receiving image data for the object from the user device; or
receiving text data from a webpage associated with the object from the user device.

4. The computing system of claim 3, wherein the image data was obtained via a browser extension on the user device.

5. The computing system of claim 1, wherein processing the historical user interaction data with the machine learning model to develop the preference profile of the first user comprises generating at least one preference, wherein generating the at least one preference comprises determining that a purchase frequency associated with the at least one preference exceeds a pre-defined threshold.

6. The computing system of claim 1, wherein processing the historical user interaction data with the machine learning model to develop the preference profile of the first user comprises utilizing a clustering algorithm to create a plurality of product category clusters.

7. The computing system of claim 1, wherein processing the historical user interaction data with the machine learning model to develop the preference profile of the first user comprises:
analyzing spending levels by a plurality of other users on at least one category; and
cleaning the historical user interaction data based on the spending levels.

8. The computing system of claim 1, wherein the operations further comprise:
receiving an indication from the second user that the object was purchased;
receiving feedback from the second user on the object; and
updating the preference profile for the first user based on the indication and the feedback.

9. A computer-implemented method performed by a server comprising:
receiving, from one or more third party networks, historical user interaction data associated with a first user;
processing the historical user interaction data with a machine learning model to generate a preference profile of the first user, wherein the machine learning model is trained to develop preference profiles based on historical user interaction data;
receiving, from a user device associated with a second user, an identifier associated with the first user;
detecting an object displayed on the user device;
generating, via the machine learning model, a compatibility score based on comparing the object to the preference profile of the first user; and
causing the compatibility score to be displayed on the user device.

10. The computer-implemented method of claim 9, wherein receiving historical user interaction data associated with the first user comprises at least one of:
receiving financial transaction data from one or more financial services networks, the financial transaction data comprising stock-keeping unit (SKU) level data;
receiving transaction data from one or more merchant networks; or
receiving at least one of receipt or order information from an email account associated with the first user.

11. The computer-implemented method of claim 9, wherein detecting the object displayed on the user device comprises at least one of:
receiving uniform resource locator (URL) information from the user device;
receiving image data for the object from the user device; or
receiving text data from a webpage associated with the object from the user device.

12. The computer-implemented method of claim 11, wherein the image data was obtained via a browser extension on the user device.

13. The computer-implemented method of claim 9, wherein processing the historical user interaction data with the machine learning model to develop the preference profile of the first user comprises generating at least one preference, wherein generating the at least one preference comprises determining that a purchase frequency associated with the at least one preference exceeds a pre-defined threshold.

14. The computer-implemented method of claim 9, wherein processing the historical user interaction data with the machine learning model to develop the preference profile of the first user comprises utilizing a clustering algorithm to create a plurality of product category clusters.

15. The computer-implemented method of claim 9, wherein processing the historical user interaction data with the machine learning model to develop the preference profile of the first user comprises:
analyzing spending levels by a plurality of other users on at least one category; and
cleaning the historical user interaction data based on the spending levels.

16. The computer-implemented method of claim 9 further comprising:
receiving an indication from the second user that the object was purchased;
receiving feedback from the second user on the object; and
updating the preference profile for the first user based on the indication and the feedback.

17. A method comprising:
activating a browser extension enabling a first user to select an object displayed within a web browser installed on a user device;
transmitting an identifier associated with a second user to a server;
in response to the first user selecting the object, obtaining information associated with the object;
transmitting the information associated with the object to the server;
receiving, from the server, a compatibility score associated with the object, the compatibility score reflecting a likelihood that the second user will like the object; and
displaying the compatibility score on the user device.

18. The method of claim 17 further comprising:
receiving an indication that the object was purchased;
receiving, from the first user or the second user, feedback on the object; and
transmitting the indication and the feedback to the server.

19. The method of claim 17, wherein the information associated with the object comprises at least one of:
uniform resource locator (URL) information from the user device;
image data for the object from the user device; or
text data from a webpage associated with the object from the user device.

20. The method of claim 17, wherein the compatibility score is generated by comparing, via a machine learning model, the information associated with the object to a preference profile associated with the second user.
